(19) United States
(12) Patent Application Publication
(10) Pub. No.: US 2008/0270654 A1
(43) Pub. Date: Oct. 30, 2008

(54) Bus System for Selectively Controlling a Plurality of Identical Slave Circuits Connected to the Bus and Method Therefore

(75) Inventor: Jacques Reberga, Saint-Loup-De-Fribois (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V., Eindhoven (NL)

(21) Appl. No.: 11/579,095

(22) PCT Filed: Apr. 20, 2005
(86) PCT No.: PCT/IB05/51290

§ 371 Date: May 30, 2008

(30) Foreign Application Priority Data
Apr. 29, 2004 (EP) 04101840.9

(51) Int. Cl. G06F 13/00

(52) U.S. Cl. 710/110

(57) ABSTRACT

A bus system (BS) for selectively controlling a plurality of identical slave circuits (slave A) comprises a bus (B) having a clock line (CLOCK) and at least one data line (DATA). The bus system (BS) includes at least one master circuit (1) and a plurality of slave circuits (2) with a group of identical slave circuits (slave A) connected to said bus (B). Each of the identical slave circuits (slave A) comprises an input-terminal (AD). The bus system (BS) further includes a selection circuit (3) connected to said bus (B), said selection circuit (3) is connected to each of said input-terminals (AD) for configuring at least one of the identical slave circuits (slave A) to be addressable by a master circuit (1) via said at least one data line (DATA).

### FIELD OF THE INVENTION

The invention relates to a bus system for selectively controlling a plurality of identical slave circuits wherein the bus system comprises a bus having at least one data line and at least one master circuit connected to said bus and a plurality of identical slave circuits connected to said bus.

The invention further relates to a method for selectively controlling a plurality of identical slave circuits of a bus system with a bus comprising at least one date line.

### BACKGROUND OF THE INVENTION

In modern electronic systems, the number of integrated circuits ICs has dramatically increased during the last twenty years because ICs are standardized circuits which can be produced at a low price and in great numbers. Therefore, the manufacturing costs of such electronic systems could be substantially reduced by employing such ICs.

However, within the electronic systems, such ICs need to communicate with each other and with off-chip elements. Therefore, a bus system has to be developed. Since the pins of the ICs limited, a serial bus system is preferred over a parallel bus system.

An example for such a serial bus system is the I2C-bus system, a serial bus system founded in 1982. The I2C-bus system is a bidirectional two-wire, serial data (SDA) and serial clock (SCL) bus for inter-IC control. Since the I2C-bus supports any IC fabrication process, a broad range of I2C-compatible chips has been developed and the I2C-bus system has become the worldwide industry standard proprietary control bus.

The I2C-serial bus uses two wires, a serial data (SDA) and a serial clock (SCL) line, for communicating between the devices connected to the bus. Each device can operate as either a transmitter or receiver, depending on the function of the device, and is recognized by a unique address. The devices can also be considered as master or slaves when performing data transfers. A master is the device which initiates a data transfer on the bus and generates the clock signals to permit that transfer. At that time, any device addressed is considered a slave. The I2C-bus is a multi master system. This means that more than one device capable of controlling the bus can be connected to it.

The transfer of data is performed on a byte-wise basis and the number of bytes that can be transmitted per transfer is unrestricted. Each byte has to be followed by an acknowledged bit. If a slave circuit can not receive or transmit another complete byte of data until it has performed some other function, for example servicing an internal interrupt, it can hold the clock line SCL low to force the master to a wait state. Data transfer then continues when the slave is ready for another byte of data and releases the clock line SCL.

Any controlling in an I2C bus system starts with a start condition which is characterized by a high to low transition on the SDA line while SCL is high, whereas a low to high transition on the SDA line while SCL is high defines a stop condition. After a start condition is initiated on the bus, the master controlling the bus usually sends a first byte including a slave address. This address is seven bit long and followed by an eighth bit which is the data direction bit (R/) which determines the direction of transmission (i.e., writing to or reading from a slave). When an address is sent, each device connected to the bus system compares the first seven bits after the start condition with its address. If they match, the device considers itself addressed by the master as a slave circuit.

A slave address can be made-up of a fixed part and a programmable part. Since it is likely that there will be several identical slave circuits in a system, the programmable part of the slave address enables the maximum possible number of such devices to be connected to the I2C-bus. The number of programmable address bits of the device depends on the number of pins available. For example, if a device has four fixed and three programmable address bits, a total of 8 (23) identical devices can be connected to the same bus.

However, some applications of an I2C-bus system with a plurality of master circuits and slave circuits connected thereto, employ slave circuits which have only one pin as programmable address bit for encoding the slave's address available. Hence, it is not possible to address more than two of these slave circuits so that a master circuit can selectively control identical slave circuits. On the other hand, it is likely that in such an electronic system more than two identical slave circuits with only one programmable pin need to be present. Therefore, the problem arises that there are more identical slave circuits present in the bus system than addressable.

One known solution to this situation is the use of separated busses each with not more than two identical slave devices. Another solution is multiplexing of multiple bus branches each with not more than two addressable identical slaves. However, the first solution has the disadvantage that masters on different busses can not access all identical slave circuits. Furthermore, this solution is not appropriate in systems where only one single bus should be used. The second solution has the disadvantage of a complex and costly bus architecture according to the number of branches which have to be multiplexed. This is in particular true, if a great number of identical slaves has to included in the bus system. In addition, both systems are not able to selectively control more than one identical slave.

In the document U.S. Pat. No. 6,629,172 a system for and a method of assigning unique addresses to multiple devices attached to an I2C-bus are disclosed. The problem to be solved by means disclosed in that document is similar to that of the invention, namely, that a master device is unable to communicate with each device individually, when multiple devices share the same common I2C-address. According to the solution know from that document for a multi-chip addressing each of the multiple devices with the same generic I2C-address need to be connected together in a serial manner and therefore need to provide two additional pins.

The process of assigning unique addresses starts with a start state, in which initially each device sharing a common, generic address are not activated to communicate with the I2C-bus. Therefore, any data transmitted along the SDA-line is not received by these devices. After that, the process activates a first device of the serially connected devices by applying an “enable” signal to one of the two additional input pins of the device. Upon this activating, the first device is ready for communication and his generic address is accessible at the SDA-line. Although each identical device shares the generic address, only the first device is currently active. Therefore, only the first device responses to the communication by the I2C-bus which transmits a first specific address for this first active device and stores this first specific address in a memory within the first device. After changing addresses, the first device sets an “enable next” signal to logic high, thereby activating the next device connected in serial to the first device so that this second device can be accessed by the serial bus using the generic address of this device. Thereafter, the same procedural steps are repeated for the second device and in this manner all devices with a common generic address connected together in serial are activated and provided with a unique address.

Although this system is capable of addressing more identical slaves than usually addressable by a master, is has several drawbacks and disadvantageous.

The method disclosed in the document U.S. Pat. No. 6,629,172 is a initialization procedure which has to be performed before all slaves of the bus system are operative, i.e. activated. If a new device of the same kind has to be integrated in the bus system, this initialization procedure has to be repeated in order to make the bus system operative. Due to the serial connection of the devices with same generic address, the number of passes through the procedural steps depends directly on the number of devices sharing the same generic address. Therefore, this method for multi-chip addressing can be time consuming if there exists a great number of devices sharing a common generic address within the bus system. Moreover, this method is not able to selectively control more than one of the devices.

Furthermore, after enabling of a device, the address stored therein has to be overwritten with a new specific address and each device need therefore to provide a rewriteable memory for its complete bus address. In addition, each of the devices need to provide two additional terminals, i.e. pins, to be connected in series with each other. Hence, no conventional already existing circuit with only one pin available can be used but independent components have to be developed, which is costly.

### OBJECT AND SUMMARY OF THE INVENTION

It is an object of the invention to provide a system of the type in the defined opening paragraph and a method of the type as defined in the second paragraph, in which the disadvantages defined above are avoided.

This object is solved by each feature combination defined in claims 1 and 8.

Further embodiments and advantageous modifications are subject to the depending claims and are herewith entirely incorporated in the description by reference so that repetition of their literally wording can be omitted.

In order to achieve the object defined above, with a system for selectively controlling a plurality of identical slave circuits according to the invention characteristic features are provided so that a device according to the invention can be characterized in the way defined below, that is:

Bus system for selectively controlling a plurality of identical slave circuits wherein the bus system comprises a bus having at least one data line and at least one master circuit connected to said bus and a plurality of identical slave circuits connected to said bus and wherein the bus system further comprises at each of the identical slave circuits an input-terminal and a selection circuit connected to said bus, said selection circuit being connected to each of said input-terminals for configuring at least one of the identical slave circuits to be addressable by a master circuit via said at least one data line.

In order to achieve the object above, with a method for selectively controlling a plurality of identical slave circuits according to the invention characteristic features are provided so that a method according to the invention can be characterized in the way defined below, that is:

Method for selectively controlling a plurality of identical slave circuits of a bus system with a bus comprising at least one date line, wherein said method comprising the following steps namely:

controlling of a selection circuit by a master circuit which wants to selectively control at least one of the identical slave circuits connected to said selection circuit;
configuring of input-terminals of at least one of the identical slave circuits by the selection circuit according to the controlling of said master circuit so that only said at least one identical slave circuit is addressable by said master circuit;
starting of the selective control of the identical slave circuits by said master circuit via said at least one data line.

The characteristic features according to the invention provide the advantage that more identical slave circuits than usually addressable can be selectively controlled within a single bus system having a simple and cost efficient structure.

In a preferred embodiment of the bus system according to the invention, the input terminal is a pin assigned to a programmable address bit of the slave circuit for determining the bus address of the slave circuit. In this way, a plurality of standardized components providing only one single programmable address pin can be used which overcomes the limitation of only two of those standardized components usable within a conventional bus system. This provides the advantage of new application fields for those standardized components which in turn results in a simple and cost efficient structure of the bus system.

In a further preferred embodiment of the invention, the selection circuit may be also a master circuit.

Alternatively ,the selection circuit can be embodied as an I/O expander, a memory or a micro controller.

In a further embodiment of the bus system according to the invention, a decoder circuit is interposed between the selection circuit and each input-terminal in order to advantageously reduce the number of pins of the selection circuit occupied by identical slave circuits.

Furthermore, with the method and the system according to the invention the advantage of using an standardized I2C-bus control and conventional I2C components as slave circuits can be achieved.

In a preferred embodiment of the method according to the invention, configuring is performed by setting the input-terminals of slave circuits to be selectively controlled to a first predetermined voltage level and keeping the input-terminals of the other slave circuits on a second predetermined voltage level. This first predetermined voltage level can be either defined as a high voltage level corresponding to logical 1 or as a low voltage level corresponding to logical 0, wherein the second predetermined voltage level is defined in each case opposite to the first predetermined voltage level.

The aspects defined above and further aspects of the invention are apparent from the examples of embodiment to be described hereinafter and are explained with reference to these examples of embodiment.

### BRIEF DESCRIPTION OF THE DRAWINGS

The invention will be described hereinafter with reference to examples to the embodiment but to which the invention is not limited.

FIG. 1 shows a bus system according to an embodiment of the invention in form of a block circuit diagram.

FIG. 2 shows a method of a bus system according to the embodiment of FIG. 1 in the form of a flow chart.

FIG. 3 shows a bus system according to a further embodiment of the invention in the form of a block circuit diagram.

### DESCRIPTION OF EMBODIMENTS

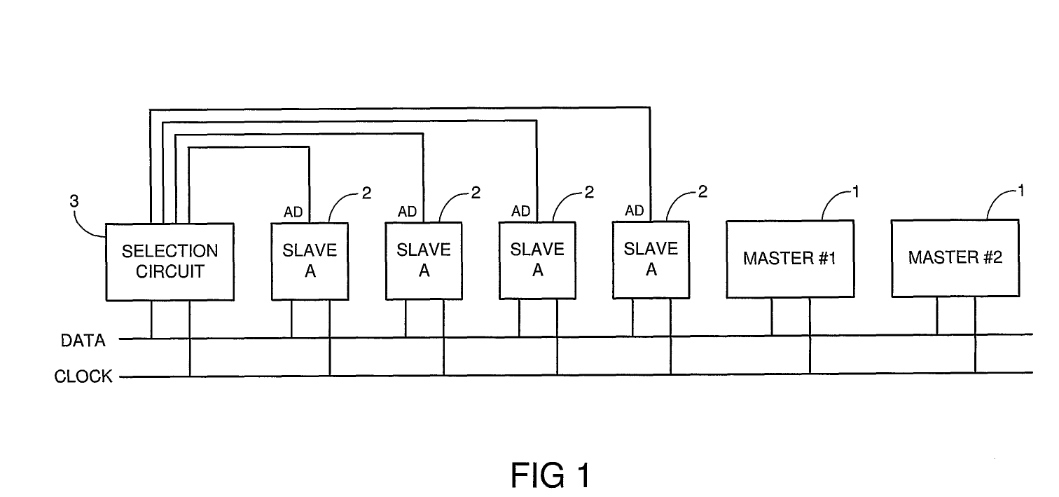

FIG. 1 shows a bus system BS according to the invention. The bus system BS is realized as a serial I2C bus system comprising a bus B with a clock line CLOCK and a data line DATA to which each of a plurality of master circuits 1 and slave circuits 2 are connected. Among these slave circuits 2 (not all are shown in FIG. 1) there is a group of identical slave circuits 2, named slaves A. Each of the slaves A comprises an input-terminal AD. These input-terminals AD are connected to a selection circuit 3 in parallel. The selection circuit 3 is also connected to the bus B, that means to the two lines CLOCK and DATA of the bus system BS so that the selection circuit 3 can be controlled by one of the master circuits 1. The input-terminal AD of a slave A is assigned to an address bit of the slave A in order to complete the I2C bus address of the slave A. The slave A can be any conventional I2C component with at least one address pin available for encoding the slave address.

When a master circuit 1 in a conventional I2C bus system wants to communicate with identical slaves A having just one address pin available for determining or encoding, respectively, their bus address, the master circuit 1 is not able to unambiguously address more than two such slaves A since only two distinguishable addresses can be programmed. Therefore, within a conventional I2C bus system, more than two slaves A cannot unambiguously be addressed by a master circuit 1. However, within a bus system BS according to the invention as, e. g. shown in FIG. 1, a selective control of slaves A more than usually addressable can be performed. The selective control is achieved by selectively configuring a pin of each slave A as explained in details below so that the slave A is addressable by a master circuit 1 according to the I2C standard.

The described bus system BS is simple in structure and due to the use of standard I2C components very cost efficient. Moreover, due to the parallel connection structure of the selection circuit and the identical slaves A, the configuring step can be performed very fast.

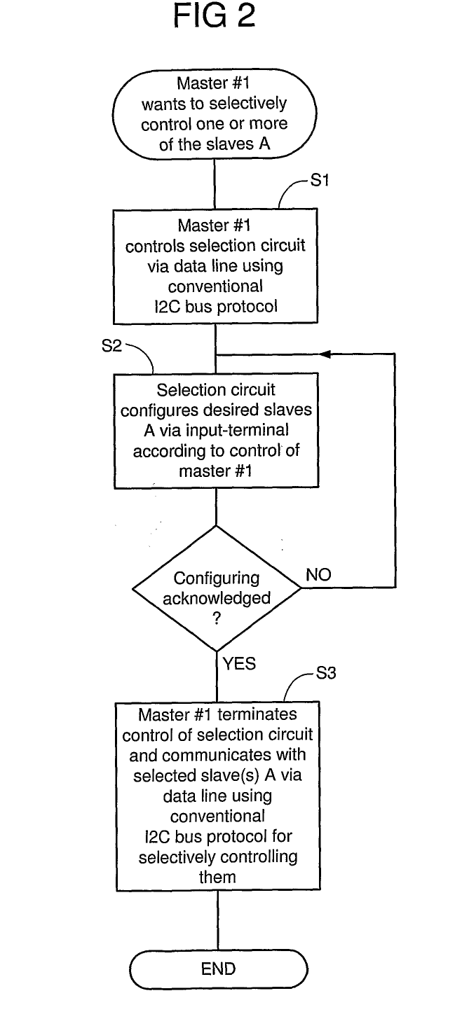

A method for selectively controlling the slaves A in FIG. 1 will now be described in detail with reference to the flowchart of FIG. 2.

If a master circuit 1 wants to control one or more of the slaves A, the master circuit 1 firstly starts to obtain control of the selection circuit 3 connected to these slaves A. Therefore, the master circuit 1 which warts to selectively control the slaves A sends the address of the selection circuit 3 on the data line DATA followed by control data to control the selection circuit 3 (see block S1 in FIG. 2).

Once the control data are received by the selection circuit 3, the selection circuit 3 configures the input-terminals AD of the identical slaves A according to the received control data so that the master circuit 1 can selectively control one of the identical slaves A. Configuring is performed by setting the input terminal AD of one of the identical slaves A to a first predetermined voltage level, which corresponds to logical 1. The input terminals AD of the remaining slave circuits A which are not to be selectively controlled by the master circuit 1 are kept on a second predetermined voltage level, which corresponds to logical 0 (see block S2 in FIG. 2).

After configuring, the bus address of the slave A, which shall be selectively controlled by the master circuit 1, has a least significant bus address bit which corresponds to 1. The remaining slaves A, which are not to be selectively controlled accordingly, have a least significant bus address bit, which correspondence to 0. All master circuits 1 within the bus system BS of FIG. 1 do know only one address, normally 0101001, for all identical slaves A. This address corresponds to the address of the previously configured slave A which is intended for selective control by a master circuit 1. According to this example, the slave address of this slave A is 0101001 and that of the remaining slaves A is consequently 0101000, which differs from the previous in the value of the least significant bit. If a master circuit 1 of the bus system BS wants to communicate with the one previously configured slave A, he has to send the address 0101001 on the data line DATA of the bus system BS.

Each master circuit 1 which wants to selectively control one of the slaves A in the bus system BS can be initially programmed to configure the slaves A by using the selection circuit 3 and then to address the previously configured slave A directly. Therefore, after receiving an acknowledge from the selection circuit 3 confirming successfully configuring of one slave A, the master circuit 1 (numbered as #1 or #2 in FIGS., 1 and 3) terminates the control of the selection circuit 3 and starts the selective control by usually addressing of slaves A using the corresponding address 0101001 on the data line DATA of the bus system BS to which only the one slave A respond, which shall be selectively controlled by the master (see block S3 in FIG. 2).

The advantage of the bus system BS according to the invention and the method according to the invention is that the number of identical slave circuits 2 which can be selectively controlled is no longer limited by the number of address bits available for programming but only limited by the physical specifications of the bus system itself, for example, the capacitive load for each bus line (e.g. 400 pF).

Furthermore, it is an advantage of the bus system BS according to the invention that only one existing pin of conventional I2C components is utilized for the selectively controlling of a slave A. Since conventional I2C components can be used, this system is very cost efficient and easy to establish.

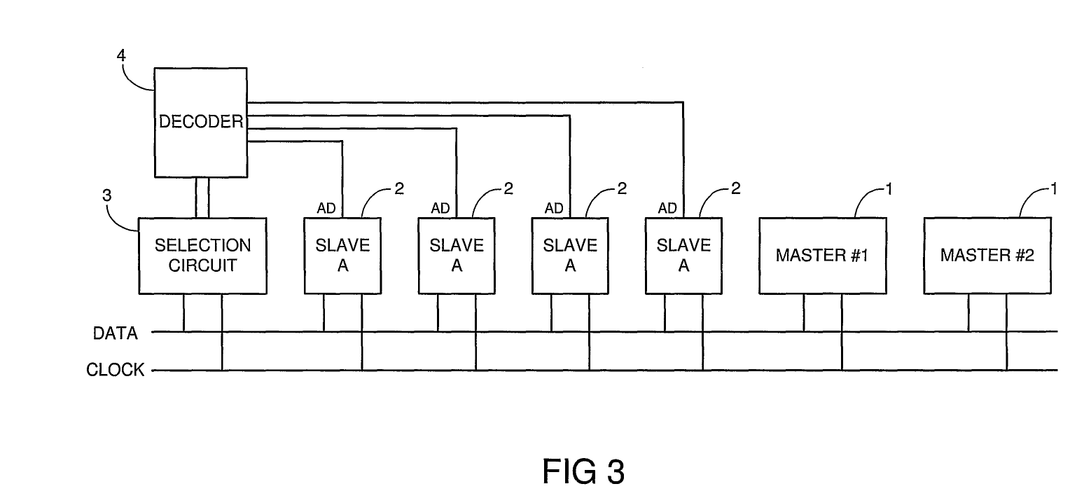

FIG. 3 shows another preferred embodiment of a bus system BS according to the invention. This embodiment comprises a decoder 4. The decoder 4 is interposed between the selection circuit 3 and the slaves A. With this structure, it is possible to reduce the number of pins of the selection circuit 3 necessary to configure the slaves A for selective control of one of the slaves A by a master circuit 1. This can be necessary in cases, where the number of slave circuits 2 that have to be configured exeeds the number of pins that are available at the selection circuit 3.

Furthermore, it should be observed that the selection circuit 3 can also be a master circuit 1 and need not to be a slave circuit 2. This has the advantage that no extra selection circuit has to be implemented. Furthermore, if such a master circuit 1 also functioning as selection circuit wants to selectively control one of slaves A, no more intermediary addressing of the selection circuit is necessary.

Furthermore, it should be observed that the selection circuit 3 can be realized in various ways, for example, as I/O expander, memory or micro controller.

A further example for a bus system BS according to the invention, is an I2C bus system wherein the selection circuit 3 is a micro controller to which TDA 8023 slave circuits are connected. A TDA 8023 circuit is a I2C chip card interface by Philips Semiconductors which is switched by an I2C bus. These circuits comprises only one address pin “SAD0” which is available for encoding the slave address. However, many applications employ more than two chip-cards in order to realize security functions or in order to adapt the application to a plurality of users. The invention described allows to utilize as many cards and thus as many TDA 8023 interfaces as necessary.

It should further be observed that the first predetermined voltage level and the second predetermined voltage level, which have been defined as logical one and logical zero respectively, could be defined the opposite way, as long as the master circuits are programmed accordingly.

Furthermore, it should be observed that according to the invention also a group of slave circuits 2 out of the ensemble of slave circuits 2 can be selected to be selectively controlled by a master circuit 1.

It has to be appreciated that reference signs within the claims are only given for illustrative purpose and shall not be construed as limiting the scope of the matter for which protection is sought.

1. Bus system for selectively controlling a plurality of identical slave circuits wherein the bus system comprises
a bus having at least one data line and
at least one master circuit connected to said bus and
a plurality of identical slave circuits connected to said bus and wherein the bus system further comprises
at each of the identical slave circuits an input-terminal and a selection circuit connected to said bus said selection circuit being connected to each of said input-terminals for configuring at least one of the identical slave circuits to be addressable by a master circuit via said at least one data line.

2. Bus system according to claim 1, wherein said input-terminal is a pin assigned to an programmable address bit of said identical slave circuits for determining the address of the slave circuit.

3. Bus system according to one of the claim 1 wherein the selection circuit is a master circuit.

4. Bus system according to claim 1 wherein said selection circuit is an I/O expander, a memory or a microcontroller.

5. Bus system according to wherein a decoder circuit is interposed between said selection circuit and each input-terminal.

6. Bus system according to wherein the bus system is a serial bus system.

7. Bus system according to claim 1, wherein the bus system is an I2C bus system and all identical slave circuits are conventional I2C components.

8. Method for selectively controlling a plurality of identical slave circuits of a bus system with a bus comprising at least one date line wherein said method comprising the following steps namely:
controlling of a selection circuit by a master circuit which wants to selectively control at least one of the identical slave circuits connected to said selection circuit configuring of input-terminals of at least one of the identical slave circuits by the selection circuit according to the controlling of said master circuit so that only said at least one identical slave circuit is addressable by said master circuit starting of the selective control of the identical slave circuits by said master circuit via said at least one data line.

9. Method according to claim 8, wherein said configuring is performed by setting the input-terminals of said at least one of the identical slave circuits to be selectively controlled to a first predetermined voltage level while the input terminals of the remaining identical slave circuits are kept on a second predetermined voltage level.

10. Method according to claim 9, wherein the first predetermined voltage level can be either defined as a high voltage level corresponding to the logical 1 or as a low voltage level corresponding to the logical 0, wherein the second predetermined voltage level is defined in each case opposite to the first predetermined voltage level.

11. Method according to claim 8, which employs the I2C bus protocol.
